(19) United States
(12) Patent Application Publication
(10) Pub. No.: US 2004/0201990 A1
(43) Pub. Date: Oct. 14, 2004

(54) LED lamp

(76) Inventor: William E. Meyer, Lincoln, MA (US)

Correspondence Address: OSRAM SYLVANIA Inc., 100 Endicott Street, Danvers, MA, 01923, US

(21) Appl. No.: 10/794,217

(22) Filed: Mar. 5, 2004

Related U.S. Application Data
(60) Provisional application No. 60/461,956, filed on Apr. 10, 2003.

(51) Int. Cl. F21V 14/00

(52) U.S. Cl. 362/255

(57) ABSTRACT

LED lamps may be effectively cooled with an atmosphere of high thermal conductivity. Hydrogen and helium are transparent gases with high thermal conductivity. Enclosing an LED light source in such a gas environment efficiently conducts heat from the LED thereby enhancing the LED's output and extending the LED's life.

### CROSS-REFERENCE TO RELATED APPLICATIONS

The Applicant hereby claims the benefit of his provisional application, Serial No. 60/461,956 filed Apr. 10, 2003 for LED Lamp.

### BACKGROUND OF THE INVENTION

1. Field of the Invention

The invention relates to electric lamps and particularly to solid-state electric lamps. More particularly the invention is concerned with solid-state electric lamps held in enclosed in an atmosphere.

2. Description of the Related Art Including Information Disclosed Under 37 CFR 1.97 and 1.98

LEDs are commonly used as light sources in a variety of lamp shapes. In general LEDs have been used as discrete elements, dispersed on an open surface. In this form the surrounding air naturally cools the LEDs. To achieve higher lamp intensity, the LEDs have to be clustered together. This increases the cumulative heat, which leads to the use of an associated heat sink. The size of the heat sink can be difficult accommodate in a lighting system. At the same time the size of heat sink can interfere with the light radiating from the lamp. There is then a need for a lamp with one or more LEDs as light sources that does not use, or can use a significantly smaller heat sink.

### BRIEF SUMMARY OF THE INVENTION

An LED lamp may be formed from a solid-state light source mounted on a support structure. A light transmissive envelope encloses the light source and support structure, and an electrical input lead and return lead pass into the envelope providing electrical energy to the light source. A low molecular weight gas fill, such as helium or hydrogen, is enclosed in the envelope to be in thermal contact with the light source. The thermal conductivity of the fill gas cools the LED source and does not interfere with light transmission.

### BRIEF DESCRIPTION OF THE SEVERAL VIEWS OF THE DRAWINGS

FIG. 1 shows a schematic, cross sectional view of an LED lamp.

### DETAILED DESCRIPTION OF THE INVENTION

The LED lamp 10 comprises a solid-state light source 12 mounted on a support structure 14. The light source 12 and support structure 14 are enclosed by a light transmissive envelope 16. Electrical input lead 18 and return lead 20 pass into the envelope 16, providing electrical energy to the light source 12. A low molecular weight, thermally conductive cooling gas 22 is enclosed in the envelope 16 to be in thermal contact with the light source 12.

The solid-state light source 12 may be an LED or a solid-state laser. Preferably it is a naked chip mounted directly on a thermally conductive support (“chip on board”), and the chip is not coated or sealed by an epoxy or other coating material. The openly exposed light source 12 then has direct contact with the surrounding cooling gas 22.

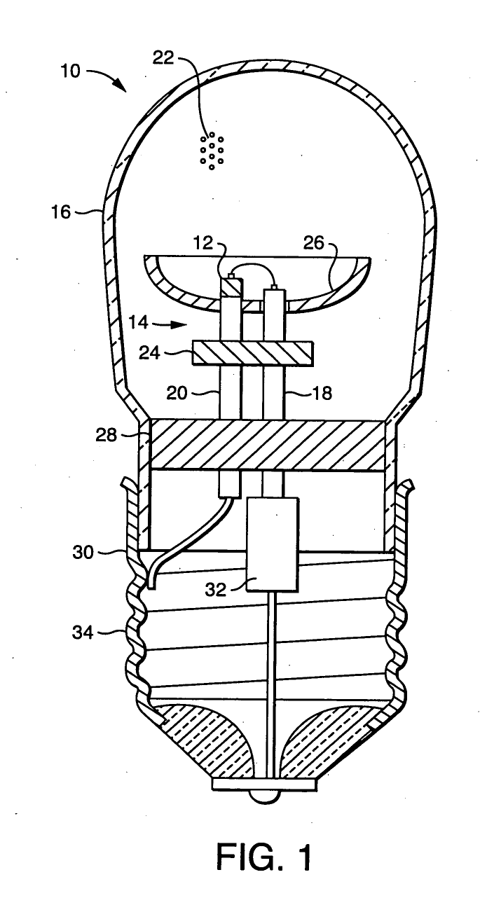

The support structure 14 may comprise metal support rods, or a common stem type support. Given the small size of the LED light source 12 and the relatively large size of the support structure 14; the mechanical leverage exerted on the light source 12 may be excessive. The preferred support structure 14 then includes a constraint 24 between the input lead 18 and the return lead 20 so bending and twisting moments between the leads 18, 20 are not or are only minimally transmitted through the light source 12. An electrically insulating bridge, glass rod or stem support may be used. Preferably the mechanical support structure 14 is as thermally conductive as possible. Preferably both the electrical input lead 18 and return lead 20 are highly thermally conductive. Copper or a similarly high thermal conductivity material may be used as the electrical input lead 18 and return lead 20. The support structure 14 may additionally include cooling features such as fins, plates or extended surfaces that spread or radiate heat over a greater area than simple straight rods. It is understood that large volume rods or similarly large mass, and large surface area supports may be used. The one electrical connector may include a reflector 26 or similarly mirrored body, wherein the reflector 26 also acts as a heat sink and thermal radiator. FIG. 1 shows a naked LED chip mounted on a thermally conductive plate, while two thermally conductive electric leads 18, 20 are coupled to the light source 12, such as an LED chip.

The light transmissive envelope 16 encloses the light source 12 and support structure 14. The preferred envelope 16 is made of glass, as it is inexpensive, easily molded into useful shapes, and can contain most low molecular weight gases to a reasonable degree. Preferable the exterior surface area of the envelope 16 is much larger than the surface area of the light source 12. Preferably the ratio of the exterior surface area of the envelope to the surface area of the light source 12 is greater than the ratio of the light source 12's temperature in Celsius to the exterior (ambient) temperature in Celsius, (typically less than 35 degrees Celsius). The envelope 16 interior need not necessarily be a particularly clean environment. It only needs to contain the cooling gas 22 at the preferred pressure. In standard incandescent lamps, it is important to keep water and oxygen away from the hot filament. Epoxies are used to coat the LED in many common constructions, but the epoxies interfere with heat conduction and light projection. The envelope 16 environment need only be as clean as that provided by the epoxy, so as to provide the same relative degree of protection from any infringing water, oxygen or other possibly injurious material. The envelope 16 may be sealed by press sealing as is known in the industry, but it may also be sealed mechanically with a mechanical plug, hardenable cement (silicon rubber, epoxy, saurising cement or similar), coating or similar material to fill to close the a fill gas opening. The seal only needs to retain the cooling gas in place at the preferred pressure. The seal may be a simple plug 28 in the envelope 16. A press seal, albeit more expensive, is preferred.

The electrical input lead 18 and return lead 20 pass into the envelope 16 providing electrical energy to the light source 12. These input lead 18 and return lead 20 may be straight rods sealed to the glass envelope 16 as is typical of a stem type. They may comprise a sealed foil input lead 18 and return lead 20 as is typical of tungsten halogen lamp assemblies. The seal need only be sufficient to reasonably contain the preferred gas 22 filling in the envelope 16, at a preferred pressure for useful life for the lamp; and to similarly keep injurious material out of the envelope. The choice of a metal lead and the glass envelope 16 is in part a matter of design choice to achieve a sufficiently good seal.

The thermally conductive gas 22 encloses the envelope 16 in thermal contact with the light source 12. The preferred gas 22 filling is helium, but it could be hydrogen or other relatively molecularly lightweight gas 22, meaning a gas with an average molecular weight that is ten percent less than the average molecular weight of air. Helium is approximately seven times more efficient as a heat conducting gas 22, than is air. For pure heat conduction hydrogen even lighter and more thermally conductive, however can be explosive in some situations, so its use presents a theoretical danger. The preferred pressure is about 0.75×10⁵ Pascals to 8.0×10⁵ Pascals (0.75 to 8 atmospheres). If the pressure is too low, the fill gas effectively acts as an insulating vacuum, thereby defeating the intended purpose of using the gas 22 to actively conduct heat away from the light source 12. If the fill pressure is too high, it offers the opportunity for the lamp to fail catastrophically, which is an undesirable result.

The envelope 16 may be supported by a base 30. The base 30 includes a mounting to receive and retain the envelope 16. The base 30 additionally includes one or more channels for receiving the exterior ends of the input lead 18 and the return lead 20. The leads 18, 20 are connected to the contacts as electrically isolated contact points for electrical connection in a correspondingly formed socket. The base 30 may be a pin, threaded, wedge or similarly shaped socket and may even be configured to fit existing sockets. Conforming the incoming power to that needed by the one or more LED's may require circuitry 32 as is known in the art that may be enclosed in the base 30. For example the base 30 may have a threaded base 30 with contacts typical of a threaded miniature bulb, for example one used in a flashlight. Adapting the gas filled envelope to the various bases (threaded, pin, wedge, bayonet, etc.) and sockets is considered to be within the skill in the art of lamp making.

It is understood that the use of only one solid state light source has been shown, a plurality may be mounted in the gas filled envelope, and that the gas cooling effect is more relevant where the number of sources is high or they are closely mounted so as to have a relatively high heat source density. While there have been shown and described what are at present considered to be the preferred embodiments of the invention, it will be apparent to those skilled in the art that various changes and modifications can be made herein without departing from the scope of the invention defined by the appended claims.

What is claimed is:

1. A lamp comprising:
a solid-state light source mounted on a support structure;
a light transmissive envelope enclosing the light source and support structure;
an electrical input lead and a return lead passing into the envelope, and electrically coupled to the light source thereby providing electrical energy to the light source; and
a low molecular weight gas fill enclosed in the envelope in thermal contact with the light source.

2. The lamp in claim 1, wherein the gas fill has a cold pressure of 0.75×10⁵ Pascals (0.75 atmospheres) or more.

3. The lamp in claim 1, wherein the gas fill is helium.

4. The lamp in claim 1, wherein the gas fill is hydrogen.

5. The lamp in claim 1, wherein the light source is a light emitting diode (LED).

6. The lamp in claim 1, wherein the light source is a laser diode.

7. The lamp in claim 1, wherein the envelope is glass.

8. The lamp in claim 1, wherein the support structure includes at least one of the electrical leads.

9. The lamp in claim 1, wherein the support structure includes thermal radiation feature.

10. The lamp in claim 9, wherein the thermal radiation feature is a heat sink.

11. A lamp comprising:
a light emitting diode (LED) light source mounted on a support structure;
a glass envelope enclosing the LED light source and support structure;
an electrical input lead and a return lead passing into the envelope providing electrical energy to the light source; and
a helium fill gas of about 1×10⁵ Pascals (1.0 atmosphere) enclosed in the envelope in thermal contact with the light source.

12. The lamp in claim 1, wherein the ratio of the exposed, exterior surface area of the envelope to the exposed surface area of the light source is greater than the ratio of the temperature in Celsius of the light source to the normal external temperature (ambient temperature) in Celsius.
